(19) United States
(12) Patent Application Publication
(10) Pub. No.: US 2008/0174521 A1
(43) Pub. Date: Jul. 24, 2008

(54) Plasma display panel (PDP) and driving method thereof

(76) Inventors: Seung-Gil Ha, Suwon-si (KR); Jae-Kwang Lim, Suwon-si (KR)

Correspondence Address: ROBERT E. BUSHNELL, 1522 K STREET NW, SUITE 300, WASHINGTON, DC, 20005-1202, US

(21) Appl. No.: 12/010,432

(22) Filed: Jan. 24, 2008

(30) Foreign Application Priority Data
Jan. 24, 2007 (KR) 10-2007-0007603

(51) Int. Cl. G09G 3/28

(52) U.S. Cl. 345/60

(57) ABSTRACT

A Plasma Display Panel (PDP) and a driving method thereof secures a drive time and improves contrast. One frame is divided into a plurality of sub fields. Each of the sub fields includes: a reset period to supply a pulse having a voltage less than or equal to a sustain voltage to scan electrodes and sustain electrodes to initialize a discharge cell; an address period to sequentially supply a scan pulse to the scan electrodes and to supply a data pulse to the address electrodes to select discharge cells to be turned-off; and a sustain period to generate a sustain discharge in discharge cells, which have not been selected during the address period while alternately supplying a sustain pulse having a negative sustain voltage to the scan and sustain electrodes.

### CLAIM OF PRIORITY

This application makes reference to, incorporates the same herein, and claims all benefits accruing under 35 U.S.C. § 119 from an application for PLASMA DISPLAY PANEL AND DRIVING METHOD THEREOF earlier filed in the Korean Intellectual Property Office on 24 Jan. 2007 and there duly assigned Serial No. 2007-0007603.

### BACKGROUND OF THE INVENTION

1. Field of the Invention

The present invention relates to a Plasma Display Panel (PDP) and a driving method thereof, and more particularly, the present invention relates to a PDP capable of sufficiently securing a drive time and improving contrast and a driving method thereof.

2. Description of the Related Art

A Plasma Display Panel (PDP) is a flat plate display, which displays images and characters by emitting light from a phosphorous material using infrared rays of 147 nm generated by a discharge of an inert gas.

FIG. 1 is a view of a discharge cell of a PDP.

With reference to FIG. 1, the discharge cell of the PDP includes a scan electrode Y, a sustain electrode X, and an address electrode A. The scan electrode Y and the sustain electrode X are formed on an upper substrate 10, and the address electrode A is formed on the lower substrate 18. The scan electrode Y and the sustain electrode X include transparent electrodes 12Y and 12X, and metal bus electrodes 13Y and 13X. The metal bus electrodes 13Y and 13X have a line width smaller than that of the transparent electrodes 12Y and 12X, and are respectively formed at an edge of one side of the transparent electrodes 12Y and 12X.

The transparent electrodes 12Y and 12X on the upper substrate 10 are formed as Indium-Tin-Oxide (ITO) electrodes. The metal bus electrodes 13Y and 13X are made of metal, such as chromium (Cr), and are formed on the transparent electrodes 12Y and 12X. The metal bus electrodes 13Y and 13X function to reduce a voltage drop due to the transparent electrodes 12Y and 12X having a high resistance. An upper dielectric layer 14 and a passivation layer 16 are stacked on the upper substrate 10, on which the scan electrode Y and the sustain electrode X are formed parallel with each other.

A wall discharge, which was generated during a plasma discharge, is stored in the dielectric layer 14. The passivation layer 16 prevents the upper dielectric layer 14 from being damaged due to sputtering generated during the plasma discharge and increases emission efficiency of secondary electrons. The passivation layer 16 is made of magnesium oxide (Mg).

A lower dielectric layer 22 and a partition 24 are formed on the lower substrate 18 on which the address electrode A is formed. Surfaces of the lower dielectric layer 22 and the partition 24 are coated with a phosphorous layer 26. The address electrode A is formed to intersect the scan electrode Y and the sustain electrode X. The partition 24 is formed in a stripe pattern and/or a mesh pattern, and prevents infrared rays and a visible light rays generated by a discharge to be leaked to an adjacent discharge cell. The phosphorous layer 26 is excited by the infrared rays generated by the plasma discharge and generates visible light rays of one of red, green, or blue color. An inert mixing gas is injected in a discharge space, which is provided between the upper and lower substrates 10 and 18 and the partition 24.

The PDP divides one frame into a plurality of sub fields having the different number of emissions and drives in a time division manner in order to embody a gradation of images. Each sub field is divided into a reset period, an address period, and a sustain period. The reset period is a time period which initializes a full screen. The address period is a time period which selects a cell while sequentially supplying a scan signal to a scan electrode Y. The sustain period is a time period which embodies a gradation according to the number of discharges.

FIG. 2 is a waveform diagram of a method of driving a PDP.

With reference to FIG. 2, sub fields of one frame are driven in such a way that they are divided into a reset period for initializing a full screen, an address period for selecting a cell to be turned-on, and a sustain period for sustaining a discharge of the selected cell.

During a first period T1 of the reset period, a ramp-up pulse is simultaneously supplied to all scan electrodes Y. In response to the ramp-up pulse, a fine discharge is generated in discharge cells of a full screen, thereby forming a wall charge at the discharge cells. The ramp-up pulse is increased from a sustain voltage to a set up voltage Vset.

During a second period T2 of the reset period, after a supply of the ramp-up pulse, the ramp-down pulse reduced from the sustain voltage Vs is simultaneously supplied to the scan electrodes Y. A slight erase discharge is generated in cells to erase a wall charge generated by a setup discharge and an unnecessary charge among space charges. This causes a wall charge necessary for an address discharge to uniformly remain in discharge cells of a full screen.

During the address period, a scan pulse is sequentially supplied to the scan electrodes Y and a data pulse is supplied to the address electrodes A. As a voltage difference between the scan pulse and the data pulse and a wall voltage generated during the reset period are added to each other, an address discharge occurs in the discharge cells to which the data pulse is supplied. A wall charge is generated in cells selected by an address discharge.

On the other hand, during the second period T2 of the reset period and the address period, a positive direct current voltage having a sustain voltage Vs is supplied to the sustain electrodes X.

During the sustain period, the sustain pulse is alternately supplied to the scan electrodes Y and the sustain electrodes X. Accordingly, a sustain discharge is generated in a discharge cell selected by an address discharge in a surface discharge pattern each time the sustain pulse is supplied by adding a wall voltage in the discharge cell to the sustain pulse.

In the PDP driven in the aforementioned operation, contrast is deteriorated by a ramp-up pulse increased to a setup voltage during a rest time period. In other words, a strong discharge is generated according to the ramp-up pulse, which is increased from the sustain voltage Vs to the setup voltage Vset. This deteriorates the contrast.

Moreover, during the address period, in order to select a discharge cell to be selectively turned on, a width of a scan pulse must be sufficiently set. As an example, the width of the scan pulse should be set to 3 μs. Accordingly, it does not secure a drive time sufficiently. In more detail, the PDP has scan electrodes Y of 480 lines. One frame period (16.67 ms) includes 8 sub fields. When a width of the scan pulse to set to 3 μs, an address period necessary in one frame is 11.52 ms. Here, the address period is 3 μs (width of scan pulse)×480 lines×8 (the number of sub fields). As described above, when the address period is widely set during one frame period, a sustain period contributed to luminance is short. Accordingly, images of sufficient luminance are not displayed.

### SUMMARY OF THE INVENTION

Accordingly, it is an aspect of the present invention to provide a Plasma Display Panel (PDP) and driving method thereof, which secures a drive time and improves contrast.

The foregoing and/or other aspects of the present invention are achieved by providing a method of driving a Plasma Display Panel (PDP) in which one frame is divided into a plurality of sub fields, each of the sub fields including: a reset period for supplying a pulse having a voltage less than or equal to a sustain voltage to scan electrodes and sustain electrode to initialize discharge cells; an address period for sequentially supplying a scan pulse to the scan electrodes and supplying a data pulse to the address electrodes to select discharge cells to be turned-off; and a sustain period for generating a sustain discharge in discharge cells, which are not selected during the address period while alternately supplying a sustain pulse having a negative sustain voltage to the scan and sustain electrodes.

Preferably, the reset period includes: a first time period for initializing the wall charge of the discharge cell; and a second time period for forming a wall charge necessary for the sustain discharge. More preferably, an ramp-up pulse is supplied to the sustain electrode during the first time period, the ramp-up pulse having a voltage increasing to the sustain voltage, and a square pulse having the negative sustain voltage is supplied to the scan electrode. Most preferably, an ramp-up pulse is supplied to the sustain electrode during the second time period, the ramp-up pulse having a voltage increasing to the sustain voltage, and a square pulse having a first voltage is supplied to the scan electrode. The first voltage is a voltage between a ground voltage and the negative sustain voltage. A reduced scan pulse is supplied to the scan electrodes during the address period, the reduced pulse having a voltage reduced to the negative sustain voltage, and a positive data pulse is supplied to the address electrodes. An address discharge is generated in discharge cells to which the scan pulse and the data pulse have been supplied. An initial sustain pulse is supplied to the scan electrodes during the sustain period. The initial sustain pulse has a width greater than that of a sustain pulse supplied after the initial sustain pulse.

According to another embodiment of the present invention, a method of driving a Plasma Display Panel (PDP) is provided, the method including: a reset period for forming a wall charge necessary for a sustain discharge in discharge cells; an address period for generating an address discharge in order to select discharge cells in which the sustain discharge will not be generated; and a sustain period for supplying a negative sustain pulse to generate the sustain discharge in discharge cells in which the address discharge will not be generated.

Preferably, the reset period includes; a first time period for supplying a first square wave to scan electrodes, and for supplying a first ramp-up pulse to a sustain electrode, the first square wave having a voltage reduced to a negative sustain voltage, and the first ramp-up pulse having a voltage increasing to the sustain voltage; and a second time period for supplying a second ramp-up pulse to the scan electrodes, and for supplying a second square wave to sustain electrodes, the second ramp-up pulse having a voltage increasing to the sustain voltage, and the second square reduced to a voltage between a ground voltage and the negative sustain voltage. More preferably, during the address period, a scan pulse is sequentially supplied to the scan electrodes, the scan pulse is reduced to the negative sustain voltage, and a positive data pulse supplied to the address electrode to select discharge cells in which the sustain discharge will not be generated. The sustain period includes alternately supplying a sustain pulse to the scan electrodes and the sustain electrodes, the sustain pulse having the negative sustain voltage.

According to another aspect of the present invention, a Plasma Display Panel (PDP) is provided in which one frame is divided into a plurality of sub fields, each of the sub fields is divided into a rest period, an address period, and a sustain period, the PDP including: discharge cells positioned at intersect points of scan electrodes, sustain electrodes, and address electrodes; a scan driver for supplying a drive wave to the scan electrodes; a sustain driver for supplying the a drive wave to the sustain electrodes; and an address driver for supplying the a drive wave pulse to the address electrodes, and for selecting discharge cells to be turned-off during the address period, wherein the scan driver and the sustain driver alternately supply a sustain pulse having a negative sustain voltage during the sustain period.

Preferably, the scan driver respectively supplies a first square wave and a first ramp-up pulse to the scan electrodes during a first time period and a second time period except for the first time period of the reset period, the first square wave having the negative sustain voltage, and the first ramp-up pulse having a voltage increasing to a sustain voltage. More preferably, the sustain driver respectively supplies a second ramp-up pulse and a second square wave to the scan electrodes, the second ramp-up pulse having a voltage increasing to the sustain voltage, and the second square reduced to a negative voltage between a ground voltage and the negative sustain voltage. Most preferably, the scan driver sequentially supplies a scan pulse to the scan electrodes during the address period, the address driver supplies a data pulse to the address electrodes during the address period.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a discharge cell of a PDP;

FIG. 2 is a waveform diagram of a method of driving a PDP;

FIG. 3 is a block diagram of a PDP according to an embodiment of the present invention;

FIG. 4 a waveform diagram of a method of driving the PDP according to an embodiment of the present invention;

FIG. 5A to FIG. 5C are views of a wall charge, formed at a discharge cell, by the drive waveform of FIG. 4; and

FIG. 6 is a view of a data pulse, supplied to a discharge cell, to turn the cell on or off during an address time period.

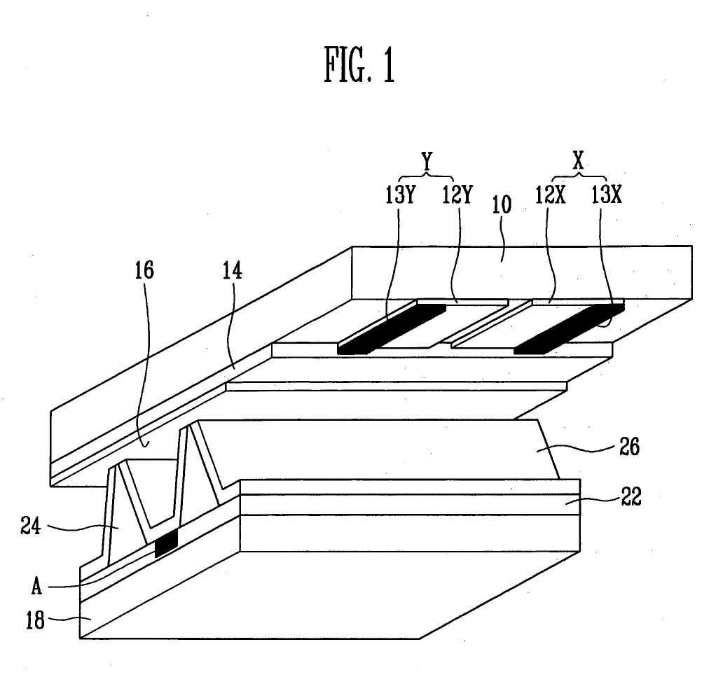

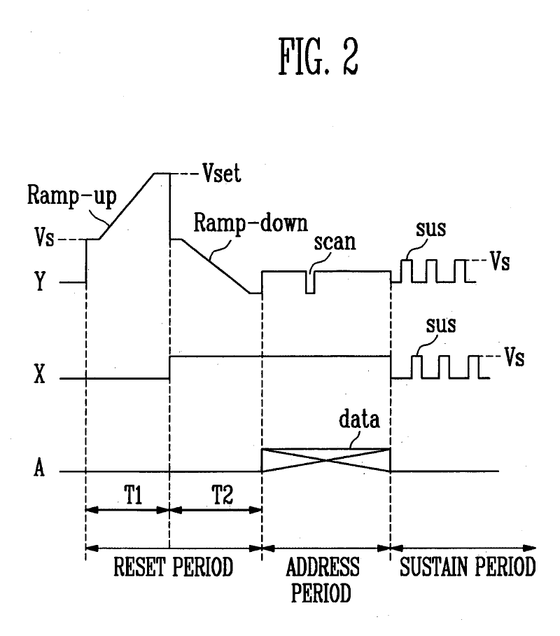

### DETAILED DESCRIPTION OF THE INVENTION

Hereinafter, exemplary embodiments according to the present invention are described in detail with reference to the accompanying drawings. When one element is connected to another element, one element may not only be directly connected to another element but also indirectly connected to another element via another element. Furthermore, unimportant elements have been omitted for clarity. Also, like reference numerals refer to like elements throughout.

FIG. 3 is a block diagram of a PDP according to an embodiment of the present invention.

With reference to FIG. 3, the PDP according to an embodiment of the present invention includes a display panel 312, an address driver 302, a sustain driver 304, a scan driver 306, a power supply unit 308, and a controller 310.

The display panel 312 includes scan electrodes Y1 to Yn and address electrodes A1 through Am. The scan electrodes Y1 to Yn are formed parallel with each other. The address electrodes A1 through Am are formed to intersect the scan electrodes Y1 to Yn. Discharge cells 314 are disposed at intersection points of the scan electrodes Y1 through Yn, the sustain electrodes X1 through Xn, and the address electrodes A1 through Am. An arrangement of electrodes Y, X, and A define the discharge cells 314 in this embodiment. However, the present invention is not limited thereto.

The controller 310 receives an external image signal and generates control signals to control the address driver 302, the sustain driver 304, and the scan driver 306. The controller 310 generates control signals so that one frame is divided into a plurality of sub fields having a reset period, an address period, and a sustain period.

The address driver 302 supplies a data pulse to the address electrodes A1 through Am during an address period of each sub filed according to a control signal supplied from the controller 310 to select discharge cells 314 to be turned off.

The sustain driver 304 supplies a negative sustain pulse to the sustain electrodes X1 through Xn during a sustain period of each sub field according to a control signal from the controller 310.

The scan driver 306 controls a drive wave to be supplied to the scan electrodes Y1 to Yn according to a control signal from the controller 310. In other words, the scan driver 306 supplies a ramp pulse to the scan electrodes Y1 through Yn so that wall charges necessary for a sustain discharge during a reset period of each sub field are formed, and sequentially supplies a scan pulse during an address period. Furthermore, the scan driver 306 supplies a negative sustain pulse to alternate with the sustain electrodes X1 to Xn during a sustain period of each sub field.

The power supply unit 308 supplies the necessary power to the controller 310 and the drivers 302, 304, and 306.

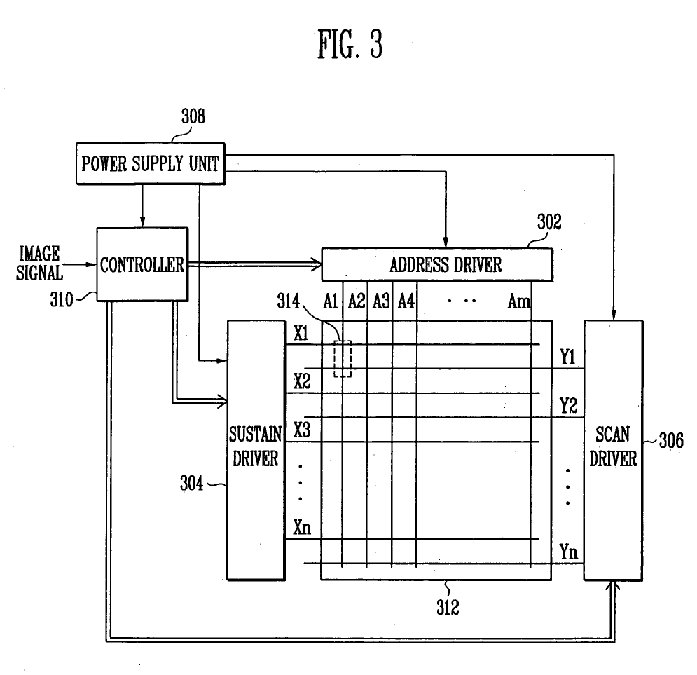

FIG. 4 a waveform diagram of a method of driving the PDP according to an embodiment of the present invention. In FIG. 4, a scan driver 306 supplies a drive wave to the scan electrodes Y, and a sustain driver 304 supplies a drive wave to the sustain electrodes X. Furthermore, the address driver 302 supplies a drive wave to the address electrodes A.

With reference to FIG. 4, in a method of driving a PDP according to an embodiment of the present invention, a sub field of one frame is divided into a reset period for initializing a full screen, an address period for selecting a discharge cell to be turned off, and a sustain period for generating a sustain discharge which is not selected during the address period.

During a first period T1 of the reset period, a first ramp-up pulse is supplied to all of the sustain electrodes X, and a first ramp-down pulse is supplied to all of the scan electrodes Y. The first ramp-up pulse is supplied to the sustain electrodes X to be slowly increased to the sustain voltage Vs. The first ramp-down pulse is supplied to the scan electrodes Y to have a negative sustain voltage −Vs of a square wave.

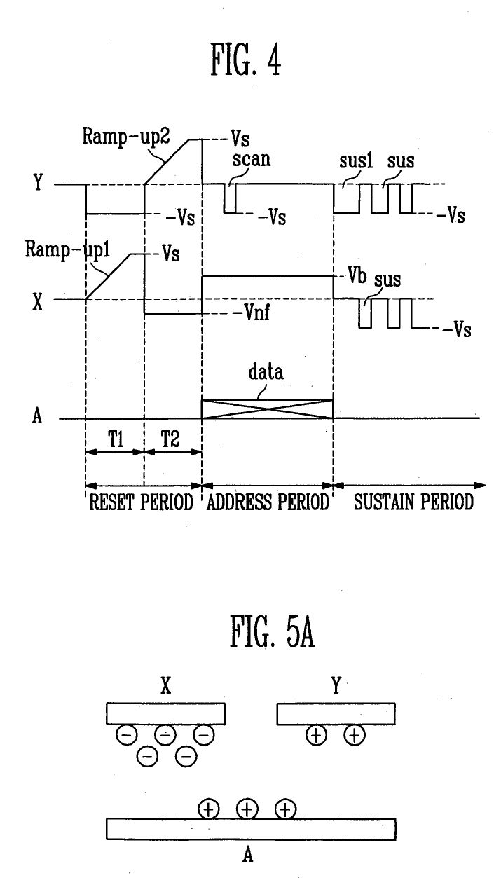

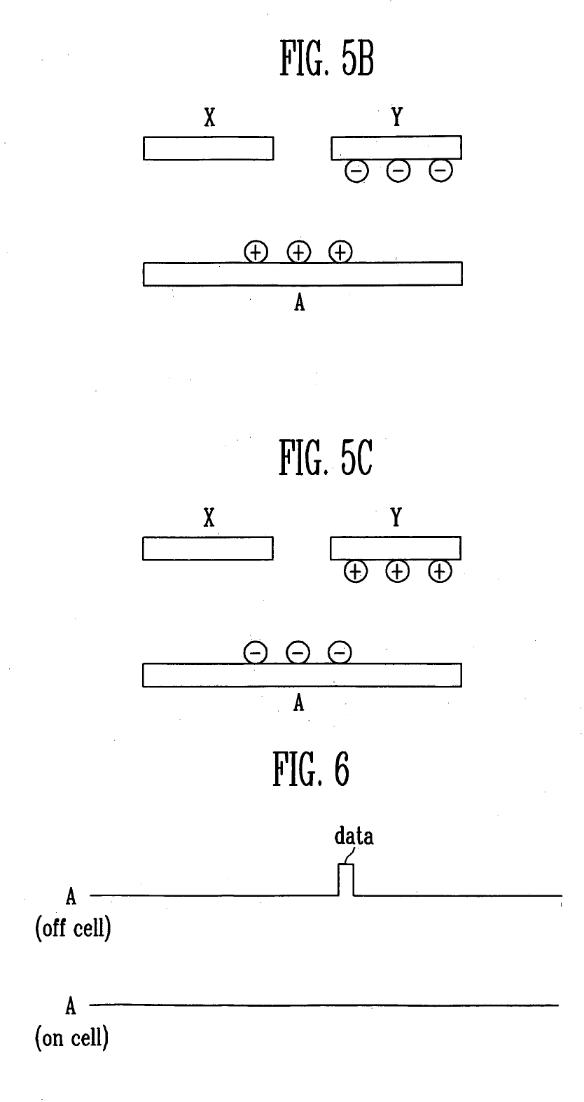

When the first ramp-up pulse and the first ramp-down pulse are supplied, a fine discharge occurs between a scan electrode Y and a sustain electrode X. In this case, as shown in FIG. 5A, a positive wall charge is stored in the scan electrode Y and a negative wall charge is stored in the sustain electrode X. Moreover, a positive wall charge is stored in the address electrode X. Through the first period T1, discharge cells of a full screen are initialized to a state of FIG. 5A regardless of a wall charge of a previous period.

During a second period T2 of the reset period, a second ramp-up pulse is supplied to all of the scan electrodes Y and a second ramp-down pulse is supplied to all of the sustain electrodes X. The second ramp-up pulse is supplied to the scan electrodes Y to be slowly increased to a sustain voltage Vs. The second ramp-down pulse is supplied to have a first negative voltage −Vnf of a square wave.

The second ramp-up pulse is added up to a voltage of a wall charge formed in the scan electrode Y during the first period. The second ramp-down pulse is added up to a voltage of a wall charge formed in the sustain electrode X during the first period. Accordingly, a fine discharge is generated between the scan electrode Y and the sustain electrode X. In this case, as shown in FIG. 5B, a negative wall charge is stored in the scan electrode Y, and the negative wall charge stored during the first period is removed from the sustain electrode X. To do this, the first voltage −Vnf is set to a voltage from which the negative wall charge stored during the first period is removed. For example, the first voltage −Vnf is set to a voltage between a ground voltage GND and the negative sustain voltage −Vs. Through the second period T2, a wall charge necessary for a sustain discharge is uniformly retained in discharge cells of a full screen.

During the address period, a scan pulse is sequentially supplied to the scan electrodes Y. Simultaneously, a positive data pulse is supplied to the address electrodes A. A voltage of the scan pulse is set to a negative sustain voltage Vs. During the address period, the data pulse is supplied to select a discharge cell to be turned off. In other words, as shown in FIG. 6, a data pulse is supplied to discharge cells which are not discharged during the sustain period. In contrast to this, a data pulse is not supplied to discharge cells which are discharged during the sustain period.

First, it is assumed that the scan pulse and the data pulse are supplied to a special discharge cell during the address period. When the scan pulse is supplied to the scan electrode Y, a voltage of the scan pulse is added to a wall charge formed in the scan electrode during the reset period. When the data pulse is supplied to the address electrode A, a voltage of the data pulse is added to a wall charge formed in the address electrode A during the reset period. Accordingly, an address discharge occurs in a discharge cell. In this case, as shown in FIG. 5C, a positive wall charge is formed at the scan electrode Y, and a negative wall charge is formed at the address electrode A.

On the other hand, the address discharge does not occur in a discharge cell to which the data pulse is not supplied. Accordingly, as shown in FIG. 5B, a wall charge formed during the reset period is maintained.

During the address period, a positive direct current voltage set to the second voltage Vb is supplied to the sustain electrode X. A value of the second voltage Vb is less than or equal to a positive sustain voltage Vs.

During the sustain period, a sustain pulse is alternately supplied to the scan electrodes Y and the sustain electrodes X. A value of the sustain pulse is set to a negative sustain voltage −Vs. Furthermore, the sustain pulse is first supplied to the scan electrodes. In this case, a width of an initial sustain pulse supplied to the scan electrodes Y is set to be wider than that of other sustain pulses. Accordingly, an initial sustain discharge stably occurs during the sustain period. This causes the next sustain discharges to stably occur.

In an occurrence procedure of the sustain discharge, wall charges as shown in FIG. 5C are generated in discharge cells in which an address discharge occurs. Accordingly, although a negative sustain pulse is supplied to the scan electrodes Y during the sustain period, the sustain discharge does not occur. In other words, since a positive wall charge is generated in the scan electrodes Y, although a negative sustain pulse is supplied, the sustain discharge is not generated.

In contrast to this, wall charges as shown in FIG. 5B are generated in discharge cells in which an address discharge is not generated. Accordingly, a voltage of a negative wall charge generated in the scan electrodes Y is added to a negative sustain pulse supplied to the scan electrodes Y during the sustain period to generate a sustain discharge. Next, a sustain discharge is stably generated in a discharge cell corresponding to the supply number of the sustain pulse to express a gradation.

As described earlier, in the present invention, a discharge cell to be selectively turned off is selected during an address period. In this case, a width of the scan pulse is set to approximately 1 μs to generate an erase discharge. Where the PDP has a VGA grade resolution, when one frame period (16.67 ms) is composed of 8 sub fields, an address period necessary in one frame is a mere 3.48 ms. That is, the present invention has an advantage that may allot a time sufficient in a sustain period contributed to luminance. The address period is 1 μs (width of scan pulse)×480 lines×8 (the number of sub fields). Moreover, because the present invention supplies only a sustain voltage during a reset period, a fine discharge is generated in comparison with the related art. Accordingly, the contrast can be improved.

As is seen from the forgoing description, in the method of driving a PDP according to an embodiment of the present invention, a discharge cell to be selectively turned off is selected during an address period. Accordingly, a scan pulse is set to have a narrow width sufficient to cause an erase discharge. This causes a drive time to be sufficiently secured. Furthermore, because the present invention supplies only a pulse having a positive or a negative sustain voltage during a reset period, a fine discharge is generated during a reset period. This causes the contrast to be improved.

Although an embodiment of the present invention has been shown and described, it would be appreciated by those skilled in the art that changes might be made to this embodiment without departing from the principles and spirit of the present invention, the scope of which is defined by the following claims.

What is claimed is:

1. A method of driving a Plasma Display Panel (PDP), the method comprising:
dividing one frame into a plurality of sub fields:
supplying a pulse during a reset period of each of the sub fields, the pulse having a voltage less than or equal to a sustain voltage supplied to scan electrodes and sustain electrodes to initialize a discharge cell;
sequentially supplying a scan pulse to the scan electrodes during an address period of each of the sub fields and supplying a data pulse to the address electrodes during the address period of each of the sub fields to select discharge cells to be turned-off; and
generating a sustain discharge in discharge cells, not selected during the address period of each of the sub fields, during a sustain period of each of the sub fields, while alternately supplying a sustain pulse having a negative sustain voltage to the scan and sustain electrodes.

2. The method as claimed in claim 1, wherein a wall charge of a discharge cell is initialized during a first time period of the reset period, and a wall charge necessary for the sustain discharge is formed during a second time period of the reset period.

3. The method as claimed in claim 2, wherein a ramp-up pulse is supplied to the sustain electrodes during the first time period, the ramp-up pulse having a voltage increasing to the sustain voltage, and wherein a square pulse having the negative sustain voltage is supplied to the scan electrodes.

4. The method as claimed in claim 2, wherein a ramp-up pulse is supplied to the sustain electrodes during the second time period, the ramp-up pulse having a voltage increasing to the sustain voltage, and wherein a square pulse having a first voltage is supplied to the scan electrodes.

5. The method as claimed in claim 4, wherein the first voltage is a voltage in a range between a ground voltage and the negative sustain voltage.

6. The method as claimed in claim 1, wherein a reduced scan pulse is supplied to the scan electrodes during the address period, the reduced pulse having a voltage reduced to the negative sustain voltage, and wherein a positive data pulse is supplied to the address electrodes.

7. The method as claimed in claim 6, wherein an address discharge is generated in discharge cells to which the scan pulse and the data pulse have been supplied.

8. The method as claimed in claim 1, wherein an initial sustain pulse is supplied to the scan electrodes during the sustain period.

9. The method as claimed in claim 8, wherein the initial sustain pulse has a width greater than that of a sustain pulse supplied after the initial sustain pulse.

10. A method of driving a Plasma Display Panel (PDP), the method comprising:
forming a wall charge necessary for a sustain discharge in discharge cells during a reset period;
generating an address discharge to select discharge cells in which the sustain discharge will not be generated during an address period; and
supplying a negative sustain pulse to generate the sustain discharge in discharge cells in which the address discharge will not be generated during a sustain period.

11. The method as claimed in claim 10, wherein;
a first square wave is supplied to scan electrodes and a first ramp-up pulse is supplied to a sustain electrode during a first time period of the reset period, the first square wave having a voltage reducing to a negative sustain voltage, and the first ramp-up pulse having a voltage increasing to the sustain voltage; and
a second ramp-up pulse is supplied to the scan electrodes and a second square wave is supplied to sustain electrodes during a second time period of the reset period, the second ramp-up pulse having a voltage increasing to the sustain voltage, and the second square wave reducing to a voltage in a range between a ground voltage and the negative sustain voltage.

12. The method as claimed in claim 11, wherein a scan pulse is sequentially supplied to the scan electrodes during the address period, the scan pulse reducing to the negative sustain voltage, and wherein a positive data pulse is supplied to the address electrodes to select discharge cells in which the sustain discharge will not be generated.

13. The method as claimed in claim 11, wherein a sustain pulse is alternately supplied to the scan electrodes and the sustain electrodes during the sustain period, the sustain pulse having the negative sustain voltage.

14. A Plasma Display Panel (PDP) in which one frame is divided into a plurality of sub fields, each of the sub fields being divided into a reset period, an address period, and a sustain period, the PDP comprising:
discharge cells arranged at intersect points of scan electrodes, sustain electrodes, and address electrodes;
a scan driver supplying a drive wave to the scan electrodes;
a sustain driver supplying the drive wave to the sustain electrodes; and
an address driver supplying the drive wave pulse to the address electrodes and selecting discharge cells to be turned-off during the address period;
wherein the scan driver and the sustain driver alternately supply a sustain pulse having a negative sustain voltage during the sustain period.

15. The PDP as claimed in claim 14, wherein the scan driver respectively supplies a first square wave and a first ramp-up pulse to the scan electrodes during a first time period and a second time period except for the first time period of the reset period, the first square wave having the negative sustain voltage, and the first ramp-up pulse having a voltage increasing to a sustain voltage.

16. The PDP as claimed in claim 15, wherein the sustain driver respectively supplies a second ramp-up pulse and a second square wave to the scan electrodes, the second ramp-up pulse having a voltage increasing to the sustain voltage, and the second square wave reducing to a negative voltage in a range between a ground voltage and the negative sustain voltage.

17. The PDP as claimed in claim 14, wherein the scan driver sequentially supplies a scan pulse to the scan electrodes during the address period, and wherein the address driver supplies a data pulse to the address electrodes during the address period.
